(19) United States
(12) Patent Application Publication
(10) Pub. No.: US 2025/0359501 A1
(43) Pub. Date: Nov. 27, 2025

(54) SOWING DEVICE

(71) Applicant: TURFCOM GMBH, Pattensen (DE)

(72) Inventors: Stefan POST, Hamburg (DE); Albrecht KNIGGE, Pattensen (DE)

(21) Appl. No.: 18/872,422

(22) PCT Filed: Jun. 5, 2023
(86) PCT No.: PCT/EP2023/064979

§ 371 Date: Dec. 6, 2024

(30) Foreign Application Priority Data
Jun. 7, 2022 (DE) 102022114232.9

(51) Int. Cl. A01C 5/04; A01B 29/04

(52) U.S. Cl. CPC A01C 5/04; A01B 29/04

(57) ABSTRACT

The present invention relates to a sowing device having a frame with at least one rotatably mounted first roller with a substantially cylindrical surface, with the first roller being designed to be rolled over a ground surface and to work seeds into the ground. The sowing device is characterized in that at least some portions, but preferable the full circumference, of the cylindrical surface of the first roller has radial indentations and radial protrusions alternating in the circumferential direction, the radial indentations each ascending radially towards at least one radial protrusion, preferably towards both radial protrusions, by way of a radial transition region.

The present invention relates to a sowing device and a first roller for a sowing device.

It is common knowledge today that lawns are not created by sowing seeds on prepared ground, but instead by laying out ready-grown turf in the form of elongated grass sods and allowing them to take root on the prepared ground. Such elongated grass sods are referred to as ready-made or rolled sods. This can speed up the process of creating a functional and virtually weed-free lawn, e.g. in the garden of a new building or on a sports field, by several months, which can be rooted and used a few days after installation. This usually means aesthetic and economic advantages due to the earlier usability. A well-produced rolled sod is also virtually weed-free, which can improve the quality of the lawn and its appearance.

The ready-made lawn sods are obtained by sowing grass seed on the relevant agricultural land. After about 10 to 18 months, the turf can be harvested by cutting strips between 2.0 cm and 3.0 cm thick out of the sod using the horizontal blade of a turf harvester. The width of the small rolls of turf usually has a width of about 40 cm or about 60 cm and is usually cut to a length of about 170 cm or about 250 cm and rolled or folded, which is where the names rolled turf and ready-made turf for lawn sods come from.

When producing ready-to-lay turf, the lawn seed can be sown in the field using conventional agricultural seed drills or special machines. Relatively simple sowing machines, for example, have been known for a long time, in which a first roller, at the front in the direction of movement or pull, opens the soil at specific points. For this purpose, cast rings provided with cams are loosely arranged on a smooth cylindrical rotatable roller of a first, front roller, i.e. both in the circumferential direction and in the transverse direction movable and in the transverse direction with several millimeters of play to each other for self-cleaning.

When the sowing machine is pulled over the ground by a tractor, the first front roller with the resulting cylindrical surface of its cast rings or cam rings rolls on the ground and penetrates the soil at certain points with the cams of the first front roller. Behind the first front roller, seed from above the first front roller then falls loosely to the ground and partly into the above-mentioned apertures in the soil, as well as substantially next to it onto the unworked surface of the soil. The seed lying on the untreated surface of the soil is then substantially pressed onto the soil or its surface by a second roller at the rear and, in part, analogous to the first roller, is pressed into the soil at certain points by the cast rings or cam rings of the second, rear roller, which are also arranged with play in the transverse direction and are provided with cams. However, substantially more of the seed is simply pressed into the unworked soil.

These types of sowing machines are therefore comparatively simple, inexpensive and robust. However, only a part of the seed is incorporated into the soil, so that a significant or substantially part of the seed remains unused and wasted. Also, this type of seeding, if seeds are incorporated into the soil, results in the seeds being worked into the soil in rows that correspond to the cams of the two rollers, which usually penetrate comparatively deep into the soil. This substantially results in uneven sowing, both in the direction of movement and in the transverse direction. This results in a certain degree of random and thus uneven distribution of the seed within the germination horizon in the soil, which is reflected in the distribution of germinating plants along the rows. Uneven seed distribution during the production of turf inevitably leads to bare patches in the turf stand, which are colonized by unwanted weeds and foreign grasses. This can negatively affect the speed with which the turf closes, and thus the quality and the production time.

US 2012/199055 A1 describes a single-pass, ground-driven tiller and seeder, which comprises: a support frame; an elongated drive rotor transversely mounted on the frame; a ground working unit that is pivotally connected to the frame and formed by a pair of rearwardly extending bearing plates and has an elongated ground working rotor, which is mounted on it and extends transversely between them, and a tightening roller, which is mounted between mounting plates that are pivotally connected to the bearing plates. The drive rotor is turned by ground contact when the apparatus is pulled by a tractor. The drive rotor is in drive engagement with the ground working rotor, so that the ground working rotor rotates at a higher speed than the drive rotor. A seed metering mechanism is attached to the frame and deposits the seed in front of the drive rotor. The ground working rotor breaks up the soil and works the seed into the soil, whereupon the reconsolidation roller consolidates the seedbed.

In the case of the soil-driven soil cutter and sowing machine of US 2012/199055 A1, on the one hand the ground working, which must precede the sowing, and on the other hand the sowing itself is carried out with the same device in a single operation. The entire apparatus is pulled over the ground by a tractor. The seed is dispensed in front of the drive rotor by the seed metering unit. The gear ratio between the first, front roller as the drive motor, which is pulled over the ground, and the second, rear roller, generates a relative movement of the second, rear roller as the ground working rotor. This means that the second rear roller does not roll “passively” on the soil but “actively” processes and opens the soil in the direction of movement, wherein the seed is simultaneously incorporated into the soil by the second rear roller. The reconsolidation roller then consolidates the seedbed.

The soil-driven soil cutter and sowing machine of US 2012/199055 A1 can thus carry out two operations in a single pass. However, here too, the distribution of the seed on the soil and its incorporation into the soil, both horizontally and vertically, is random and therefore uneven, which can be disadvantageous when using lawn seed as seed to produce rolled lawns, as mentioned earlier. This applies in particular to the depth at which the lawn seed is introduced into the soil, since the processing or opening takes place at a significantly greater depth than is beneficial for optimal germination of lawn seed, namely in the region of 5 mm to 10 mm.

The object of the present invention is to provide a sowing device of the type described above, so that the introduction of seeds, in particular lawn seeds, into the soil or germination horizon can be improved. This should be possible in a more defined manner, particularly with regard to a more even transverse distribution than previously known. In addition or as an alternative, this should be done in particular in the depth of the soil, i.e. with regard to the location and depth of the germination horizon. In any case, this should be as simple, cost-effective, precise, robust and/or low-maintenance as possible. At the very least, an alternative to the familiar sowing devices should be created.

The object is achieved by a sowing device and a first roller with the features of the independent claims. Advantageous further developments are described in the subclaims.

Thus, the present invention relates to a sowing device. Such a sowing device can be any device that is suitable for sowing seeds. The seed can preferably be lawn grass seed, so that the sowing device according to the invention can preferably be used to sow lawn grass. In principle, however, the sowing device according to the invention can be used for any type of seed. In any case, the sowing device according to the invention can be moved over the ground into which the seed is to be placed. For this purpose, the sowing device can be pushed or pulled, which-depending on the size of the sowing device and the application-can be done by one person or by means of a vehicle such as a garden vehicle like a lawn tractor or an agricultural vehicle like an agricultural tractor. Alternatively, the sowing device can also be embodied to carry out the movement itself by means of a corresponding drive. Thus, the sowing device according to the invention can be used both in the home garden for sowing seeds, in particular lawn seeds, and on agricultural land for sowing various seeds, in particular lawn seeds, for the production of ready-to-use turf. For this purpose, the sowing device according to the invention can be scaled accordingly, depending on the application.

The sowing device has a frame with at least one rotatably mounted first roller with a substantially cylindrical surface, wherein the first roller is designed to be rolled over a soil and to incorporate seed into the soil. As previously mentioned, rolling over the ground as a surface can be self-propelled or externally driven or moved. In any case, the first roller can be rotatably mounted on the rack, which can also be referred to as a frame or holder, in order to be rolled over the ground or floor by moving the rack. In other words, the first roller rolls passively over the ground or on the ground, so that no relative movement in the direction of movement and thus no relative speed occurs between the ground and the first roller. This minimizes the contact of the first roller with the soil. This also applies to the substantially cylindrical surface of the first roller.

The sowing device according to the invention is characterized in that the cylindrical surface of the first roller has, at least in portions, preferably over its entire circumference, in the peripheral direction, alternating radial indentations and radial protrusions, wherein the radial indentations each rise radially by means of a radial transition region towards at least one radial protrusion, preferably towards both radial protrusions.

In other words, the peripheral profile of the first roller according to the invention is designed, at least in portions, in such a manner that the radial indentations each have a radially deepest point, from which the radial indentations increase radially in the peripheral direction towards at least one side to an immediately adjacent protrusion and preferably towards both sides to the respective immediately adjacent protrusion, and thus approach the radius of the radial protrusion. The radial protrusions can also be referred to as radial elevations. This avoids a digital change, so to speak, of radial indentations with a constant smaller radius and radial elevations with a constant larger radius, as is known from the state of the art described at the beginning, in which cast rings or cam rings are provided with cams at certain points.

The present invention is based on the realization that the cast rings or cam rings, which are provided with cams at selected points, of conventional simple sowing machines only lead to apertures in the soil at selected points, which, due to the mobility of the cast rings or cam rings on their roller bodies, are randomly arranged in the direction of movement and in the transverse direction and are also only randomly filled with seed. A substantially larger part of the soil remains untouched, so that only seeds can be pressed on there. This leads, on the one hand, to an uneven germination horizon with patchy growth and, on the other hand, to a significant waste of seed that does not germinate.

According to the invention, alternating radial indentations and radial protrusions are formed, which merge into one another, so to speak, in that the radial distance between a radially deepest point of a radial indentation and an immediately adjacent radial protrusion or its radially highest point is reduced. In this manner, a transition region or transition portion can be created in the circumferential direction of the first roller, so to speak, from the radially deepest point of a radial indentation to the directly adjacent radial protrusion, which can be regarded as belonging to the radial indentation.

When a peripheral profile of this kind, as found on the first roller of the sowing device according to the invention, is rolled over the soil, not only the radial protrusions themselves but also at least the transitional areas of the radial indentations can penetrate into the soil and thus press seeds into the soil. This increases the surface area of the first roller, which can be used to incorporate seeds into the soil, so that more seeds than previously known can be introduced into the germination horizon and thus utilized.

The depth of penetration of the first roller into the ground is also limited at least by the radial indentations or their deepest points, since the deepest points of the radial indentations come to rest on the ground and thus prevent or at least significantly impede deeper penetration of the surface of the first roller into the ground. This can limit the depth to which seed can be pressed into the soil by the first roller. This can be constructively specified or predetermined by the radial distance between the radial indentations or their radially deepest points and the radial protrusions.

The transition areas of the radial indentations also increase the surface area of the first roller to roll on the ground, which can also reduce the depth of penetration, since the weight of the roller can be distributed over a larger area. Nevertheless, due to the weight of the first roller, a sufficient desired depth of penetration can be achieved to insert the germination horizon into the soil at the desired depth.

Furthermore, the surface of the first roller can be shaped with radial indentations, transition areas and radial protrusions to ensure that the first roller rolls on the floor by being pulled over it, and is not pulled over the floor or through the floor while stationary.

If the first roller is formed completely, i.e. in the circumferential direction, with radial indentations, transition areas and radial protrusions, this can increase the corresponding effect or enable it over the entire circumference of the first roller.

It is also possible to provide several differently shaped first rollers, which can be used alternatively. Since the degree of penetration of the radial protrusions and radial indentations into the ground can depend on its composition, different first rollers can be provided which, for example, differ in the design of their radial indentations and/or radial protrusions and can thus be suitable for different types of soil. In the case of the first rollers with roller disks, as will be explained in more detail below, the first rollers may also differ in the number, thickness or strength, and spacing of their roller disks. In any case, the user can exchange the different first rollers with each other in order to adapt the sowing device according to the invention to the respective soil. For this purpose, the first rollers can be exchanged as a whole, or only the roller disks of the first rollers can be exchanged opposite a roller shaft or changed in the distance in the transverse direction to one another. This can expand the scope of use.

According to one aspect of the invention, the radial indentations are concave. In other words, the radial notches and thus also their radial transition areas, as sub-areas of the radial notches, have a radially inwardly curved half-arc in the circumferential direction, the two ends of which extend as radial transition areas to the two directly adjacent radial protrusions, without reaching them or preferably adjoining or merging with the two directly adjacent radial protrusions. In other words, the two immediately adjacent radial protrusions can either protrude radially with respect to the respective end of the radial transition area or they can close directly on one another. In any case, the properties and advantages described above can be realized in concrete terms, with varying degrees of effect, which can increase the design scope.

According to a further aspect of the invention, the radial protrusions are convex, preferably with the shape of the completely cylindrical surface of the first roller. This can minimize the penetration of the radial protrusions into the ground, since the convex surface of the radial protrusions can help them to roll on the ground. This can also simplify the production of the first roller from a fully cylindrical body or from circular roller disks, in the surface of which the radial indentations can then be made.

According to a further aspect of the invention, the radial indentations extend in the circumferential direction at least 3 times, preferably at least 5 times, and at most 10 times, preferably 7 times, particularly preferably approximately 6 times, as far as the radial protrusions.

In addition or as an alternative, the radial indentations each preferably extend over at least 2% of the circumference, preferably over at least 3% of the circumference, and at most over 6% of the circumference, preferably over 5% of the circumference, particularly preferably over approximately 4% of the circumference.

In addition or as an alternative, the radial protrusions each preferably extend over at least 0.3% of the circumference, preferably over at least 0.5% of the circumference, and maximally over 1.5% of the circumference, preferably over 1.0% of the circumference, particularly preferably over approximately 0.7% of the circumference.

In addition or as an alternative, the radial indentations are set back from the radial protrusions by at least 3% of the radius, preferably at least 5% of the radius, and at most 10% of the radius, preferably 7% of the radius, particularly preferably approximately 6% of the radius, preferably in the radial direction.

The respective relations between the dimensions of the radial indentations, the radial protrusions, the circumference and/or the radius can be used, in particular in combination with each other, to achieve the highest possible effect as described above.

According to a further aspect of the invention, the first roller is suspended from the frame of the sowing device in a freely oscillating manner by means of at least one supporting arm, preferably at each end by means of a supporting arm. In other words, the first roller is not fixed in position relative to the frame, but is instead arranged so that it can rotate, as this would cause the first roller to move across the uneven floor surface with its surface, which would result in comparatively poorly sown areas of soil. Such areas of soil would therefore hardly be overgrown, which, for example, when sowing lawn grass, could lead to gaps in the turf that could be used by foreign grasses, as described at the beginning. According to the invention, the first roller is rotatably suspended on the supporting arm and the supporting arm is freely swinging or pivotally suspended on the frame, so that the first roller can be lifted above the surface of the ground. This allows the first roller to move up and down to follow the contours of the ground, so that the seed can be applied as described above, even on an uneven surface, to ensure that the vegetation is as uniform as possible. Using two end trim arms can increase the stability of the first roller against the frame and/or prevent the first roller from wedging against the frame.

A supporting arm stop is preferably provided in at least one direction of movement of the supporting arm, and preferably in both directions of movement of the supporting arm. This can limit the evasive movement of the first roller in the vertical plane to prevent the first roller or its supporting arm from colliding with the frame.

According to a further aspect of the invention, at least one, preferably exchangeable, roller damper is provided between the frame of the sowing device and the first roller, preferably a roller shaft of the first roller, which is designed to counteract a spring deflection of the first roller in a damping manner. This can be used to dampen or slow down the evasive movement of the first roller in the vertical direction in order to counteract it. Also, by appropriately training and arranging the roller damper opposite the first roller, pressure can be applied vertically to the first roller to influence or determine the pressure with which the first roller acts on the ground. This can favor the introduction of the seed into the soil.

In particular, this can be influenced by the fact that different roller dampers with different spring forces can be exchanged and used, so that the user can adjust the effect described above for the respective floor or adapt it to the respective floor. In any case, the roller damper can be designed as an elastic body, for example as a metallic or elastomeric spring, which can enable a robust, simple and/or compact implementation in each case. Such an elastic body can in particular act directly on the first roller or its roller shaft. In particular, metallic spiral springs can be used as a robust and durable implementation.

Preferred realization can be done by means of spring pairs acting in parallel, in particular by means of metallic spiral spring pairs or metallic spiral spring packages. Two identical or two different springs can be used in terms of their forces, which can increase the design freedom.

In each case, the spiral spring(s) can be arranged around a preferably cylindrical guide so that the spiral springs can be guided in their movement and stabilized perpendicular to it. These guides can be permanently connected to a respective holder of the roller damper.

In any case, the roller damper or its springs and in particular its metallic spiral springs can be connected to one side of the already mentioned holder in a fixed manner, wherein the holders as roller damper holders can each be provided with one or with the frame of the sowing device in a fixed but differently positionable manner. This allows a certain adjustment to be made to the springs, particularly in terms of height, in relation to the first roller, which in turn allows the spring force to be influenced or adjusted. This also allows for adjustment to different springs. This adjustable positioning can preferably be achieved by means of different holes or similar on the holder, so that different specific or discrete positions can be set for the respective holder on the frame of the sowing device.

In any case, the respective spring can also act indirectly on the first roller by providing a tappet between the spring and the first roller, which can be moved to a certain extent along the direction of action of the spring and thus can be pressed onto the first roller by the spring by means of its spring force. In this case, one contact surface of the tappet, preferably curved, can be in contact with the first roller. The tappet can be connected to the corresponding end of the spring by means of a tappet connection. In the case of a spiral spring, this tappet connection can also extend into the interior of the spiral spring in order to achieve a guide for the tappet in relation to the spiral spring. If a guide is provided within the spiral spring, the tappet connection can also interact with the spring guide. In any case, the first roller can have a tappet receiver against which the tappet can act or press. The tappet holder can be designed in particular as an extension of a supporting arm.

According to a further aspect of the invention, the first roller has a plurality of, preferably fixed, roller discs which are arranged parallel to one another and have, at least in portions, preferably over their entire circumference, in the peripheral direction, alternating radial indentations and radial protrusions, wherein the radial indentations and radial protrusions of several roller disks, preferably all roller disks, are arranged corresponding to one another or offset in the peripheral direction. In other words, the first roller is not formed from a cylindrical roller body but has a plurality of individual roller disks that are arranged parallel to one another and together form the first roller. For this purpose, the roller disks can be arranged fixed on a common roller shaft, which can be rotatably mounted on the frame or on the supporting arm or arms.

In any case, this can simplify the manufacturing process and thus also make it more cost-effective, since manufacturing individual roller discs and joining them together can be easier than processing a full body. This may apply in particular to identical rollers, which can be manufactured multiple times. This can also increase the design freedom, since the radial indentations and radial elevations can be more easily incorporated into the circumference of a roller disc than on a cylindrical roller. In particular, different roller discs can be used in combination, which can significantly increase the design options.

In any case, spaces can be created between the individual rollers in the transverse direction, where the soil cannot be touched by the first rollers or their roller disks. The width or thickness of the roller disks and the spaces between them can also be used to influence the incorporation of the seed into the soil. In particular, the weight of the first roller can be reduced as a result, on the one hand compared to a full-surface roller and on the other hand between first rollers with different thick or strong roller disks among themselves, which can also influence the degree to which the first rollers or their roller disks can penetrate into the soil.

Preferably, the roller disks of the first roller are to be formed at the same time and aligned in the transverse direction so that the radial indentations and radial protrusions are congruent when viewed in the transverse direction, it may be possible to introduce the seed bodies of the seed into the soil in a grid, which, with regard to the distances between the individual seed bodies, can be the same and defined both in the longitudinal direction as the direction of movement and in the transverse direction. This can, in particular, enable the seeds to be evenly distributed in the germination horizon.

According to a further aspect of the invention, at least one second roller with a plurality of, preferably fixed, roller disks is rotatably mounted on the frame, preferably in the direction of movement behind the first roller, wherein the roller disks of the first roller and the roller disks of the second roller engage one another in the direction of movement and are preferably arranged alternately in the transverse direction. As a result, the spaces formed between them in the transverse direction by the roller disks of the first roller can be used partially or, if the roller disks are arranged alternately in the transverse direction, completely by the roller disks of the second roller in order to engage in the spaces at least in sections, in particular in the longitudinal or movement direction.

Accordingly, seed can also be placed in the soil between the roller disks of the first roller, i.e. in the region of the spaces between the first roller, and placed in the soil by the roller disks of the second roller. This can preferably be done as described above, by designing the roller disks of the second roller to be comparable or identical to the roller disks of the first roller, as will be described in more detail below. In any case, the advantages of a second roller made up of roller disks can be utilized while simultaneously incorporating the seed into the soil over as large an area as possible. For this purpose, the roller disks can be designed and arranged in the transverse direction with as few gaps as possible, in order to work the seed into the soil over as large an area as possible and at the same time, in particular when the spacing between their axes of rotation in the longitudinal or direction of movement is as small as possible.

However, such distances between the directly adjacent roller disks can also be deliberately provided in the transverse direction in order to avoid contact between these roller disks during operation, which can be caused by manufacturing and mounting tolerances and can lead to the roller disks rubbing against one another. This can cause noise and increase wear and the effort required to move the sowing device according to the invention.

However, the deliberate or significant distance between the immediately adjacent roller disks in the transverse direction can also favor the incorporation of the seed into the soil, since soil thrown up laterally by the roller disks of the first roller can be pushed back into the soil depressions left by the roller disks of the first roller, together with the seed, by the roller disks of the second roller, which is the rear roller in the direction of movement.

The use of two interlocking rollers also allows the first roller to clean itself with the second roller, and vice versa, in that soil particles and the like that remain in the spaces between the first roller after contact with the ground and at least partially clog the spaces can be removed by the roller disks of the second roller, and vice versa. This can be achieved by turning the area of the first roller upwards and the area of the second roller downwards, so that the two rollers engage in opposite directions, which can increase the self-cleaning effect.

According to a further aspect of the invention, the roller disks of the second roller have radial indentations, radial transition regions and radial protrusions, which are preferably designed and/or arranged like those of the roller disks of the first roller. This means that the corresponding properties and advantages of the roller disks of the first roller, as described above, can be transferred to the roller disks of the second roller and applied there as well.

According to a further aspect of the invention, a disc spacing between a roller disk of the first roller and a roller disk of the second roller that is immediately adjacent in the transverse direction is less than the disc thickness, preferably approximately half the disk thickness, of the roller disk of the first roller and/or the roller disk of the second roller. This means that the spaces between the directly adjacent roller disks of both rollers can be kept small enough to prevent soil material from entering there. This can be achieved by using a disk spacing of approximately half the disk thickness, which also prevents the roller disks from rubbing against each other, which could cause noise and wear and hinder movement.

According to a further aspect of the invention, the roller disks of the first roller, preferably fixed, are arranged on a roller shaft of the first roller and the roller disks of the second roller, preferably fixed, are arranged on a roller shaft of the second roller, wherein the shaft distance between the roller shaft of the first roller and the roller shaft of the second roller is as small as possible to exclude contact between a roller disk and a roller. This allows the roller disks of one roller to penetrate the spaces between the roller disks of the other rollers as completely as possible, and vice versa, which can promote self-cleaning as described above.

According to a further aspect of the invention, the second roller is suspended from the frame of the sowing device in a freely oscillating manner by means of at least one supporting arm, preferably at each end by means of a supporting arm. A supporting arm stop is preferably provided in at least one direction of movement of the supporting arm, and preferably in both directions of movement of the supporting arm.

According to a further aspect of the invention, at least one, preferably exchangeable, roller damper is provided between the frame of the sowing device and the second roller, preferably a roller shaft of the second roller, which is designed to counteract a spring deflection of the first roller in a damping manner. This means that the corresponding features of the first roller can be applied to the second roller to realize the corresponding properties and advantages there as well, as described above.

As an alternative to suspending the two rollers with a supporting arm each, the first roller and the second roller can also be rotatably mounted on a pendulum holder, wherein the pendulum holder is rotatably mounted on the frame so that the two rollers can be tilted together about the transverse axis with respect to the ground. This allows a certain degree of flexibility and adaptability to the ground for both rollers together, while keeping the corresponding effort low.

The pendulum holder can be designed in particular as a triangle, so that an upper pivot point of the pendulum holder is connected to the frame and allows rotary movement. The two rollers can be equally spaced along the longitudinal axis to the upper pivot point, forming an isosceles triangle.

According to a further aspect of the invention, the sowing device has at least one, preferably height-adjustable and/or exchangeable, track loosener, which is arranged in front of the first roller in the direction of movement of the sowing device and preferably in front of a harrowing unit and/or in front of a sowing unit, and is designed to engage in the soil and loosen it. The track loosener is thus designed to be arranged in the longitudinal or direction of movement of the sowing device according to the invention, at least in front of the first roller, and to engage the soil in such a manner that loosening of the soil can take place. Loosening the soil should not be understood to mean ground working, such as plowing or similar, which penetrates much deeper and is more laborious than with the track loosener. Such preparatory ground working is preferably not part of the sowing device according to the invention at all and must be carried out accordingly with separate apparatus and devices in a preceding working process. Rather, the track loosener is used only to loosen the soil near the surface in front of the first roller in the event that it has been a long time since the previous processing and the soil in the surface area has hardened again and/or if the soil in the surface area has been compacted by a person's feet and/or a pulling device with a wheel. According to the invention, this is to be reversed by means of the track loosener, so that the seed can then be placed in the desired germination horizon in loose soil, as described above.

Preferably, the track loosener is located at the sowing device where a wheel of a pulling device rolls on the ground. This can favor the loosening effect of the track loosener precisely where compaction of the soil has occurred with the wheel of a pulling device such as a tractor.

In addition or as an alternative, the track loosener preferably has a plurality of foot elements with contact surfaces for substantially horizontal engagement in the ground, which are preferably designed to be height-adjustable and/or interchangeable. Due to the vertical positioning and/or design of the contact surfaces of the foot elements, this can have a loosening effect precisely in the area of the ground surface. In particular, horizontal intervention can favor processing as close to the surface as possible down to approximately the depth of the desired germination horizon.

Providing the foot elements with height adjustment can enable the user to adjust or position the foot elements or their contact surface vertically as desired. Additionally or alternatively, preferably providing the foot elements in an interchangeable manner can enable the simple and quick use of different foot elements, for example depending on the respective ground, and/or their replacement in the event of wear or damage.

Preferably, the contact surfaces of the foot elements are curved towards the ground in the direction of movement and/or in the transverse direction, at least in portions. This can favor an intervention in the ground that is only close to the surface but at the same time covers a large area in order to loosen the entire horizontal as far as possible, but at the same time limit this to the region of the ground close to the surface, which corresponds to the region in the vertical up to the germination horizon.

According to a further aspect of the invention, the sowing device has at least one harrowing unit, preferably height-adjustable and/or interchangeable, which is arranged in front of the first roller in the direction of movement of the sowing device and is designed to smooth the soil, preferably behind a track loosener and/or in front of a seeding unit. A harrowing unit is a mechanical arrangement of protrusions pointing towards the ground or its surface, which touch the surface of the ground and can thereby smooth it. In particular, no or no significant intervention in the ground or its surface is to be made by this, but rather protrusions of the surface of the ground as well as soil parts or soil lumps lying on the surface of the ground are to be distributed and/or crushed in order to prepare the ground as smoothly and uniformly as possible before the seed is applied to the ground and worked into the ground at least by the first roller as described above. For this purpose, the harrowing unit or its individual harrows can be arranged with their ends or tips pointing diagonally against the direction of travel and thus be pulled “dragging” over the ground or its surface in the direction of travel, so to speak, in order to merely graze the ground and thereby smooth it. This can be done, for example, at an angle of approx. 50° to the ground or its surface.

Preferably, the harrowing unit has a plurality of harrows, which are arranged in rows next to one another in the transverse direction and are aligned with an open end towards the ground in order to make smoothing contact with it. This can constitute a concrete possibility for implementation.

Preferably, the harrows are resiliently designed and/or resiliently mounted on the harrowing unit, preferably height-adjustable and/or replaceable. This can make it easier for the harrow or its tips to only touch and smooth the surface of the ground, but to interfere as little or not at all with the ground, which could contradict the desired smoothing effect. The harrow can be height-adjusted and/or interchangeable, which allows the harrow unit to have the same properties and advantages as the track loosener.

According to a further aspect of the invention, the sowing device has at least one, preferably height-adjustable and/or exchangeable, sowing unit, which is arranged in front of the first roller in the direction of movement of the sowing device and preferably after a track loosener and/or after a harrowing unit and is designed to apply seed to the soil. This allows the sowing device itself to apply the seed, which can save additional effort. Providing a height adjustment and/or interchangeability of the seed unit in this case can also enable the implementation of the corresponding properties and advantages as already described above with regard to other structural parts.

Preferably, the seed unit has an outlet opening which extends in the transverse direction at least in sections, preferably completely, across the width of the first roller. This allows the seed to be applied to the surface of the ground transversely to the longitudinal or direction of movement of the sowing device, which can favor a targeted and defined introduction of the seed into the ground.

Preferably, the outlet opening is slit-like in the transverse direction. This can favor a defined positioning of the seed on the surface of the ground.

In addition or alternatively, the seed unit preferably has a first wall and a second wall which extend in the transverse direction and together form, at least in portions, an internal hopper space from which the individual seed grains can emerge towards the ground via the outlet opening, wherein at least one of the walls is formed at an angle to the vertical direction in such a way as to allow seed grains to bounce off towards a, preferably slot-like, outlet opening. This can make it easier to slow down the seed before it emerges from the outlet opening due to the impact and thereby allow it to fall onto the ground aligned as far as possible in the transverse direction to one another. This can help to align the seed in the transverse direction to one another.

The present invention also relates to a first roller for use in a sowing device as previously described, wherein the first roller is adapted to be rotatably supported on a rack of the sowing device, wherein the first roller has a substantially cylindrical surface, wherein the first roller is adapted to be rolled over a ground and to incorporate seed into the ground, wherein the cylindrical surface of the first roller has alternating radial indentations and radial protrusions in the circumferential direction at least in sections, preferably in their entirety, and wherein the radial indentations each rise radially towards at least one radial protrusion, preferably towards both radial protrusions, by means of a radial transition area. In this manner, a first roller can be provided in order to be able to implement a sowing device according to the invention as described above.

Several exemplary embodiments and further advantages of the invention are illustrated and explained in more detail below, purely schematically, in connection with the following figures. Shown are:

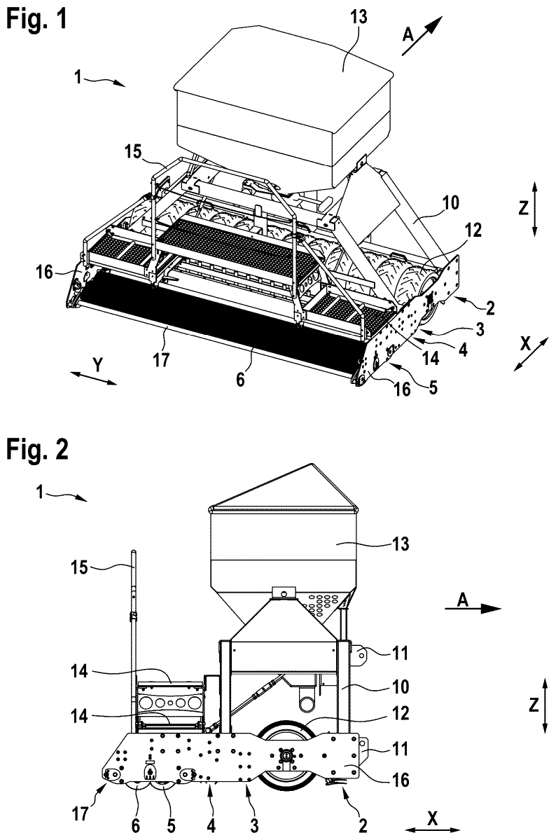

FIG. 1 shows a perspective view of a sowing device according to the invention according to a first embodiment example from the rear at an angle from above;

FIG. 2 shows the right-hand side of FIG. 1;

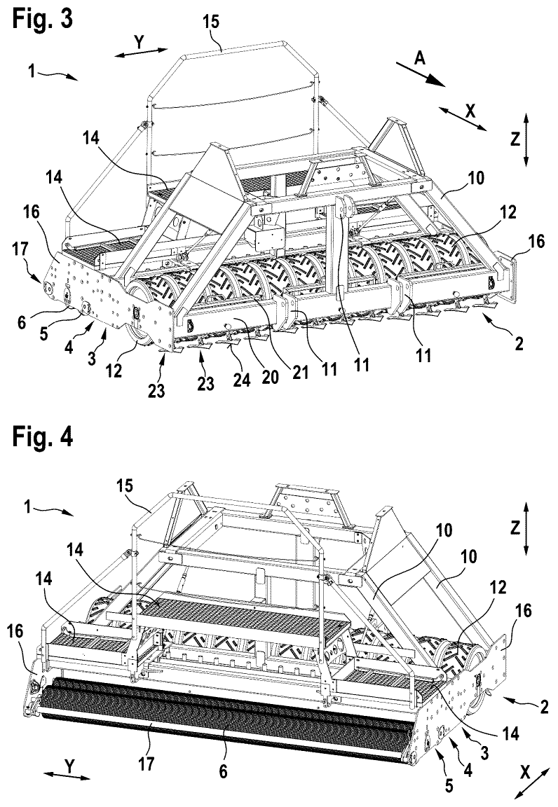

FIG. 3 shows FIG. 1 from the front at an angle without the seed container;

FIG. 4 shows FIG. 3 from the rear at an angle;

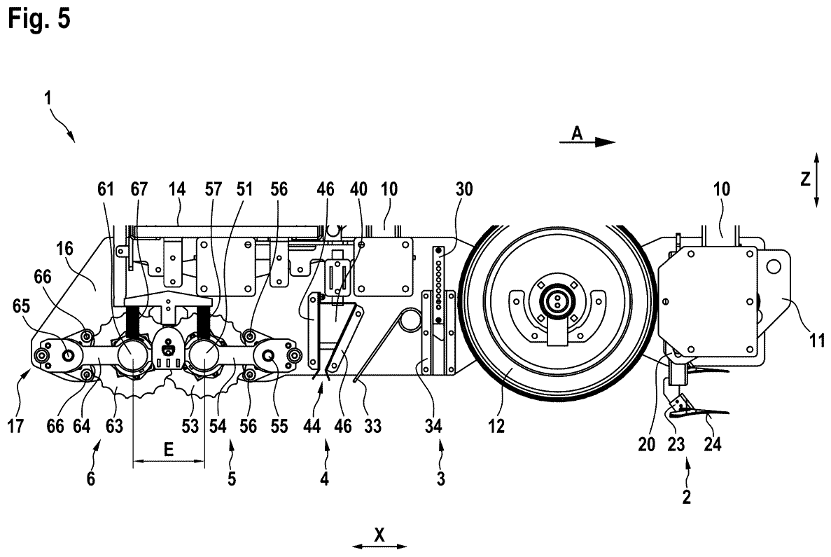

FIG. 5 shows a detailed view of the lower area of FIG. 2;

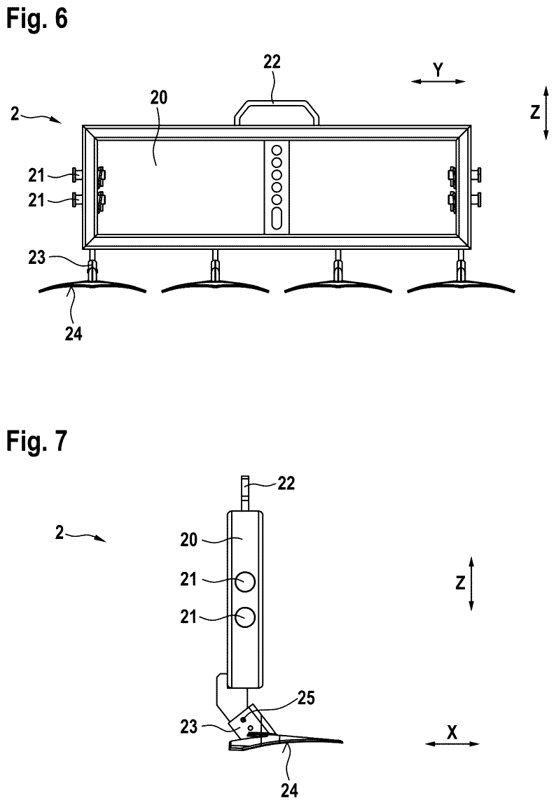

FIG. 6 shows a front view of a track loosener;

FIG. 7 shows the right-hand side of FIG. 6;

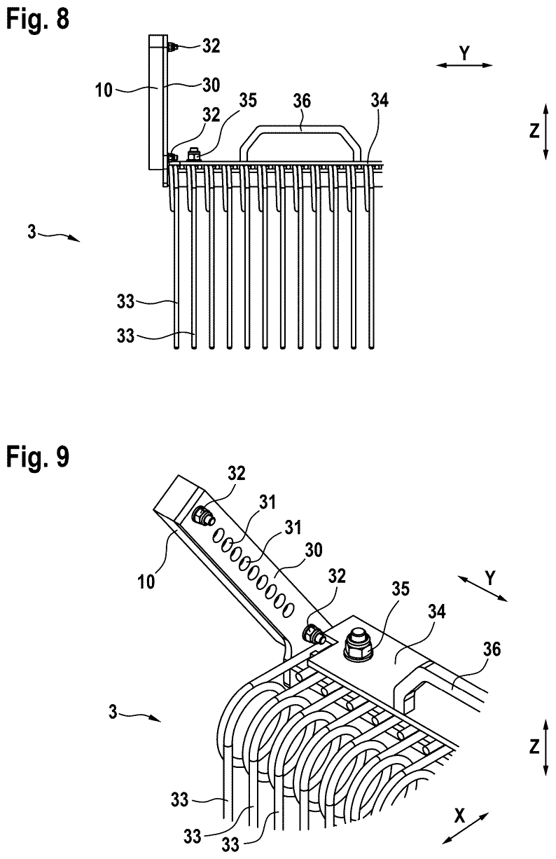

FIG. 8 shows a harrowing unit 3 from the rear, inclined at an angle of approx. 30° to the installation situation;

FIG. 9 shows a perspective view of FIG. 8 from the top rear, at an angle of approx. 30° to the installation situation;

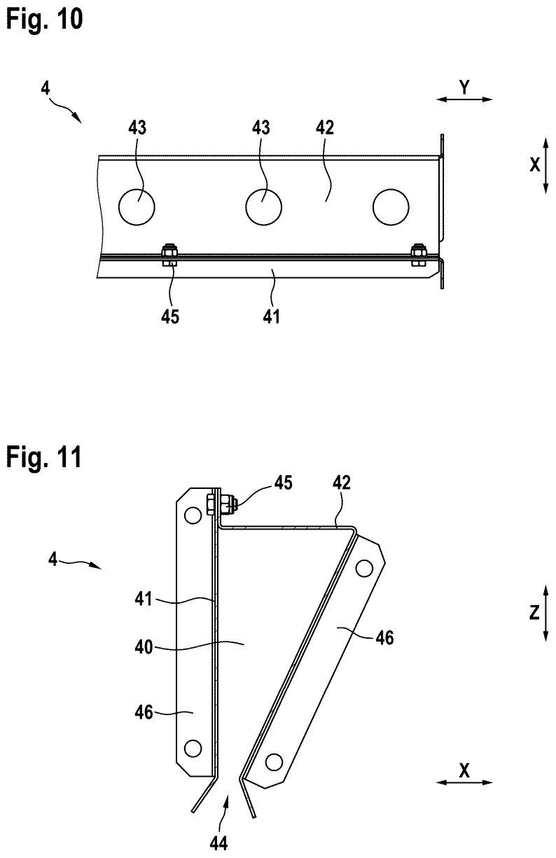

FIG. 10 shows a top view of a seed unit;

FIG. 11 shows a longitudinal section through the seed unit of FIG. 10;

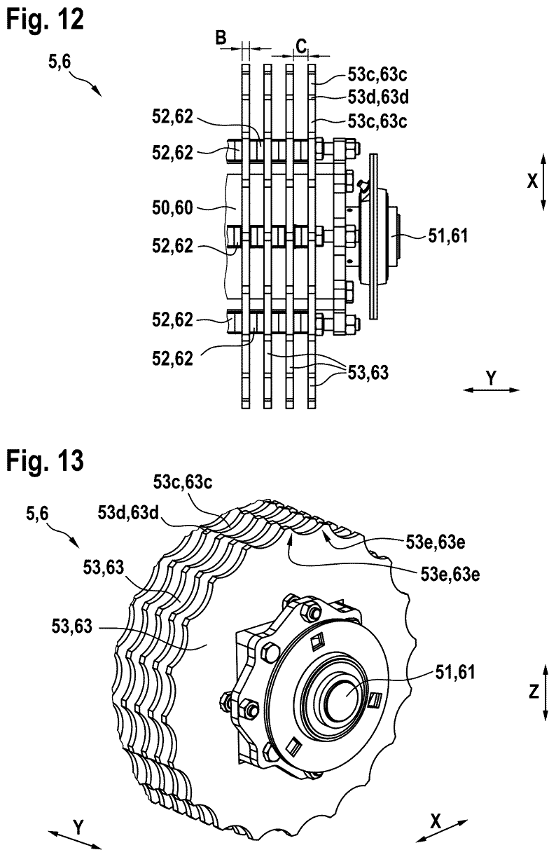

FIG. 12 shows a top view of a first or second roller;

FIG. 13 shows a perspective view of FIG. 12 from the top rear;

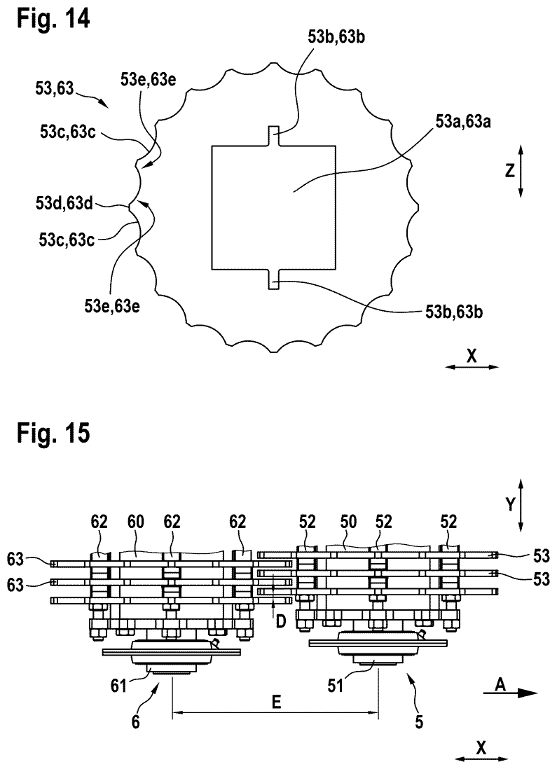

FIG. 14 shows a side view of a roller disk of the first or second roller;

FIG. 15 shows a top view of the two interlocking rollers;

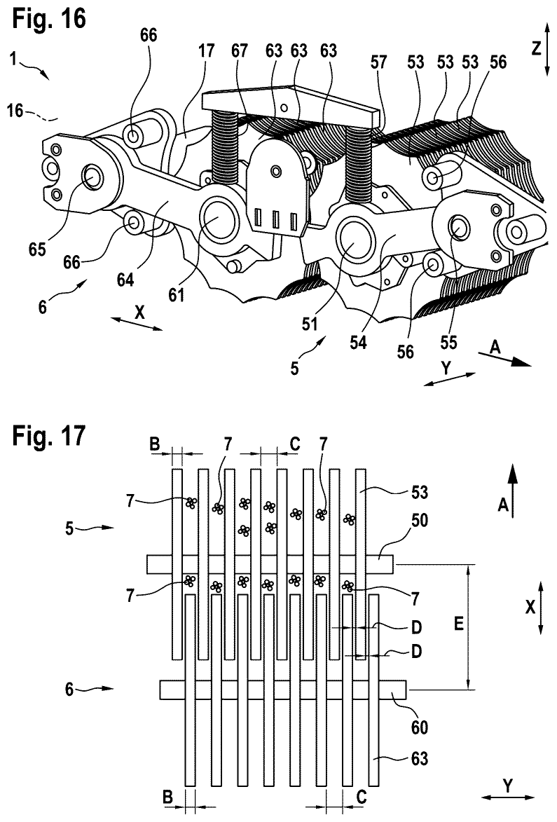

FIG. 16 shows a perspective view of the rear area of FIG. 5 from the front at an angle;

FIG. 17 shows a principle sketch with interlocking rollers;

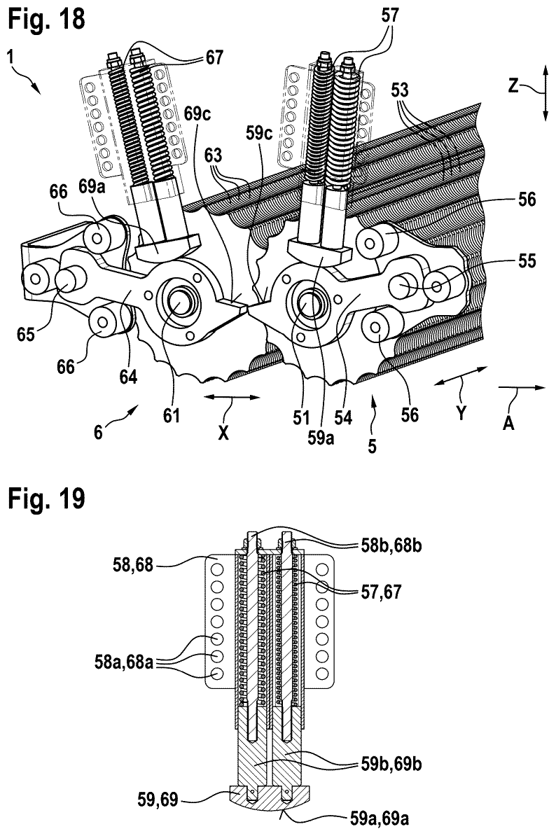

FIG. 18 shows a perspective view of the rear region of FIG. 5 according to a second embodiment example from the front obliquely above;

FIG. 19 shows a top view of a roller damper of FIG. 18;

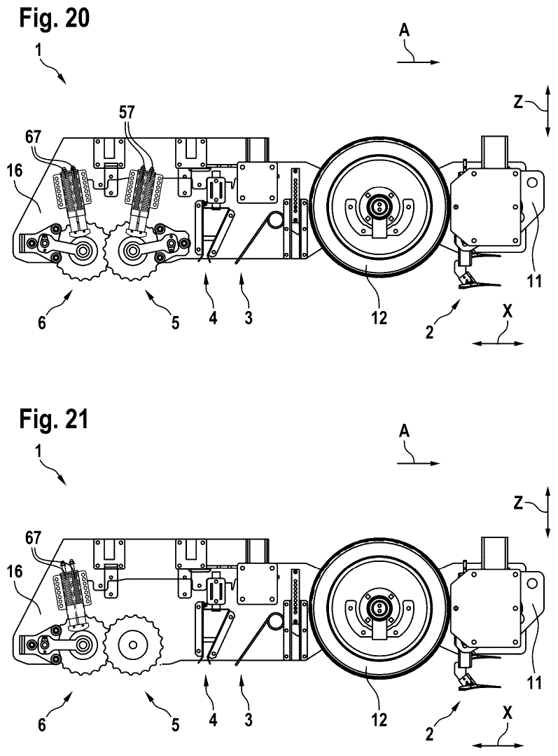

FIG. 20 shows a detailed view of the lower area of FIG. 2 according to the second embodiment of FIG. 18;

FIG. 21 shows a detailed view of the lower area of FIG. 2 according to a third embodiment;

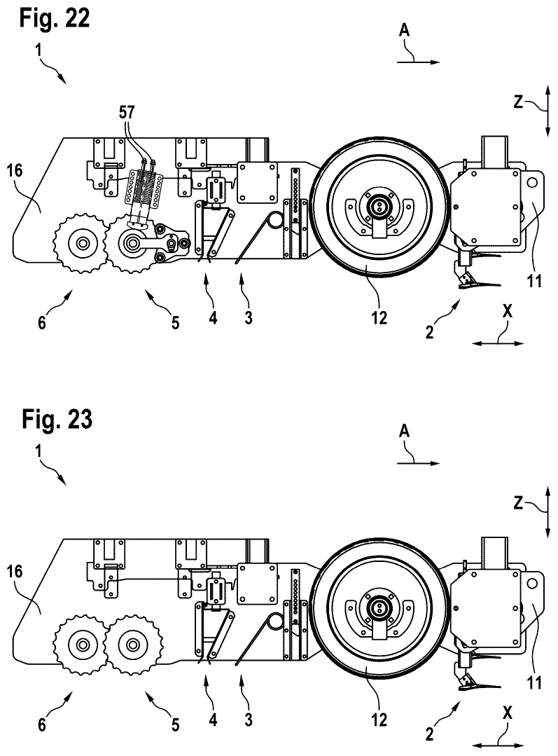

FIG. 22 shows a detailed view of the lower area of FIG. 2 according to a fourth embodiment;

FIG. 23 shows a detailed view of the lower area of FIG. 2 according to a fifth embodiment;

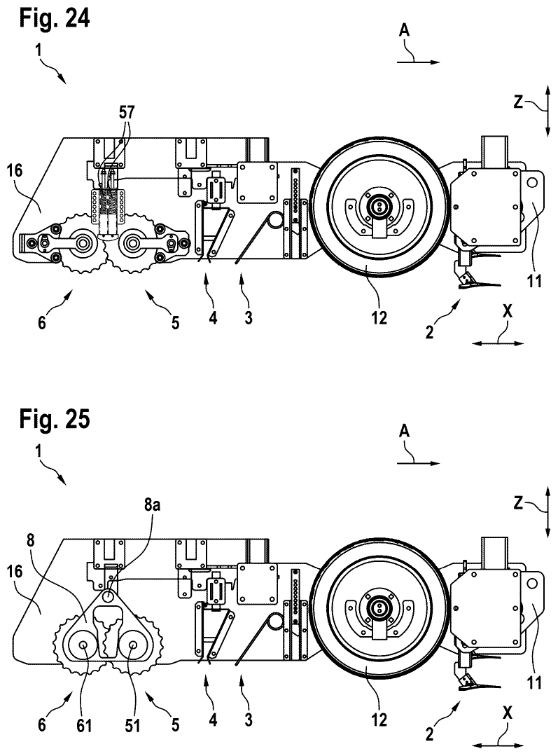

FIG. 24 shows a detailed view of the lower area of FIG. 2 according to a sixth embodiment; und

FIG. 25 shows a detailed view of the lower area of FIG. 2 according to a seventh embodiment.

The above figures are viewed in Cartesian coordinates. A longitudinal direction X is shown, which can also be referred to as depth X or as length X. A transverse direction Y, which can also be referred to as width Y, extends perpendicular to the longitudinal direction X. A vertical direction Z extends perpendicular to both the longitudinal direction X and the transverse direction Y, which can also be referred to as height Z and which corresponds to the direction of gravity. The longitudinal direction X and the transverse direction Y together form the horizontal X, Y, which can also be referred to as horizontal plane X, Y.

A sowing device 1 according to the invention according to a first embodiment example is considered, using the example of a sowing machine 1 as an agricultural apparatus which is used for sowing lawn seeds and for this purpose can be pulled by a tractor (not shown) over a ground as a substrate (not shown).

Sowing machine 1 has a rack 10 that forms the frame or holder for the components of sowing machine 1. In the longitudinal direction X, which also represents a direction of movement A or a pulling direction A of the sowing machine 1, three vehicle couplings 11 are arranged on the rack 10 in a triangular arrangement facing the tractor, see for example FIG. 3, in order to be connected to the tractor as a towing vehicle.

The rack 10 has various structural parts or components, which are arranged one behind the other in the longitudinal direction X and parallel to one another in the transverse direction Y between two side holders 16 of the rack 10, see for example FIGS. 1 to 5. A seed container 13 is provided in the vertical Z above these structural parts, which can be reached by a user via several stepping surfaces 14 past a railing 15.

In the longitudinal direction X and in the direction of motion A, a track loosener 2 is arranged between the two side holders 16. A rubberized roller 12 is rotatably mounted between the two side holders 16, with which the sowing machine 1 can roll on the ground when the sowing machine 1 is pulled by the tractor in the direction of movement A. This is followed by a harrowing unit 3. After the harrowing unit 3, a seeding unit 4 is provided, which can receive seed 7 from the seed container 13 in the vertical direction Z and deliver it to the ground.

For incorporating the seed 7 or the grains of seed 7 or the seeds 7, a first, front roller 5 and a second, rear roller 6 are rotatably arranged between the side holders 16, which can also be designated as a first, front seed roller 5 and a second, rear seed roller 6. The sowing machine 1 is aligned in the longitudinal direction X with a fixed crossbar 17, which holds the two side holders 16 together in the transverse direction Y and stabilizes them in relation to one another, see for example FIGS. 1 and 4.

The track loosener 2 is used to loosen the soil in the area close to the surface immediately in front of the sowing machine 1, which can be done by means of a plurality of foot elements 23, which are arranged next to one another in the transverse direction Y. The track loosener 2 has three holders 20, which can each be mounted by means of holder fasteners 21 on the frame 10 of the sowing machine 1 in at least two different positions in the vertical direction Z, see for example FIGS. 6 and 7. This can be at least an upper position, in which engagement of the foot elements 23 with the ground can be prevented, and a lower position, in which engagement of the foot elements 23 with the ground can take place. Further positions are possible in which different depths of intervention in the ground can be made using the foot elements 23. The adjustment of the respective holder 20 in the vertical direction Z can be carried out by the user by means of a handle 22.

In order to realize an intervention in the soil that is as extensive as possible and at the same time close to the surface, each holder has 20 four foot elements 23 arranged next to one another in the transverse direction Y, which are each exchangeably arranged on the respective holder by means of a foot element fastening 25. Each foot element 23 has a contact surface 24, which is curved in the longitudinal direction X with the ends pointing towards the ground and also curved in the transverse direction Y with the ends pointing towards the ground. This enables a particularly effective near-surface intervention in the ground, in particular to loosen the two regions behind the tractor wheels after they have been compacted by the tractor.

In the longitudinal direction X, the rubberized roller 12 is connected to the track loosener 2, as already mentioned, which is rotatably mounted between the side holders 16 and rolls on the ground when the tractor pulls the sowing machine 1 over the ground, see for example FIGS. 3 and 5. The rubberized roller 12 has several rubber tires arranged next to one another, which distribute the weight of the sowing machine 1 as evenly as possible on the ground so as not to compact it again.

The rubberized roller 12 is now followed in the longitudinal direction X by the aforementioned harrowing unit 3, which has a holder 30 that is continuous in the transverse direction Y, one edge region of which is shown in FIGS. 8 and 9. The holder 30 of the harrowing unit 3 has a plurality of holding passage openings 31 in each edge area, through which holding fasteners 32 in the form of holding screws 32 can be passed, in order to be able to mount the holder 30 and thus the entire harrowing unit 3 in different positions in the vertical direction Z on the rack 10 of the sowing device 1. This allows the harrowing unit 3 to be adjusted vertically Z to a certain extent in relation to the ground.

The harrowing unit 3 has a plurality of springy harrows 33, which are arranged next to one another in the transverse direction Y and are each interchangeably mounted on the holder 30 of the harrowing unit 3 by means of a common harrow holder 34. The harrow holder 34 is detachably held on the holder 30 of the harrowing unit 3 by a plurality of harrow fastenings 35 in the form of harrow fastening screws 35. The harrow holder 34 also has a plurality of handles 36 for a user to be able to handle the harrowing unit 3 and position it vertically in the Z direction.

The individual harrows 33 have a metallic design and are bent in a spiral shape, which enables the spring-elastic effect to be achieved in relation to the ground. Accordingly, the tips of the harrow 33 can press resiliently on the ground and smooth it out.

The seed unit 4 arranged downstream in the longitudinal direction X picks up the seed 7 in the vertical direction Z from above from the seed container 13 into a hopper interior 40, which is formed by a first wall 41 and by a second wall 42, see for example FIGS. 10 and 11. The first wall 41 extends substantially in the plane of the vertical direction Z and the transverse direction Y, with the lower area of the first wall 41 as an edge bent away in the longitudinal direction X against the direction of movement A, see for example FIG. 11. The second warning 42 initially forms a cover (not shown) of the hopper interior 40 in the horizontal X, Y direction, which has a plurality of inlet openings 43 spaced apart from one another in the transverse Y direction, which guide the seed 7 from the seed container 13 into the hopper interior 40 by means of hoses (not shown). The second warning 42 then extends in the vertical direction Z obliquely inclined to the rear against the direction of movement A, so that the hopper interior 40 narrows downwards in the vertical direction Z towards an outlet opening 44, which represents an outlet slot 44 extending continuously in the transverse direction Y. The lower end of the second wall 42 is also bent away, but in the direction of movement A. Both walls 41, 42 are held by holding elements 46 on the rack 10 of the sowing machine 1 and are connected to one another in the upper area by wall connections 45.

The seeding unit 4 thus applies the seed 7 or the seed grains 7 in the transverse direction Y in a linear and comparatively evenly distributed manner to the ground or its surface. The seed 7 is then worked into the ground in the vertical direction Z in order to form a germination horizon that is as uniform as possible at a predetermined depth of approximately 5 mm to 10 mm.

The seed 7 is worked into the ground by the combination of the first, front roller 5 and the second, rear roller 6. For this purpose, both rollers 5, 6 have a plurality of roller disks 53, 63, which are each arranged fixedly in the transverse direction Y on a roller shaft 50, 60 through a shaft holder 53a, 63a, see for example FIG. 12. The roller disks 53, 63 each have a disk thickness B in the transverse direction Y and are arranged along their roller shaft 50, 60 with respect to one another by spacer bodies 52, 62, which are received by spacer body receptacles 53b, 63b of the roller disks 53, 63, at a disk spacing C from one another, see for example FIGS. 12 and 17.

The roller disks 53, 63 are arranged alternately in the transverse direction Y, so that the roller disks 53, 63 interlock alternately, i.e. are each partially located in the space between the other roller 5, 6, see for example FIG. 17. This allows the two rollers 5, 6 to self-clean in such a manner that the roller disks 53, 63 of one roller 5, 6 can clear the spaces between the roller disks 53, 63 of the other roller 5, 6 of soil particles and the like, which can accumulate there during operation. This can be achieved particularly effectively by providing a disk spacing D in the transverse direction Y between the roller disks 53, 63 of the two rollers 5, 6, which corresponds approximately to half of a disk thickness B of the engaging roller disks 53, 63, see for example FIG. 17. This can also be favored by keeping a shaft distance C in the longitudinal direction X between the two roller shafts 50, 60 as small as possible, see also FIG. 17, for example.

In order to introduce the seed 7 or the seed grains 7 into the ground as evenly distributed as possible in the horizontal X, Y and, on the other hand, to form the germination horizon there as far as possible at a predetermined depth in the vertical Z, the roller disks 53, 63 are designed in their circumferential direction at the edge or at the edge in such a manner that concave radial indentations 53c, 63c alternate continuously with radial protrusions 53d, 63d. The regions of the radial indentations 53c, 63c, which rise concavely radially towards the radial protrusions 53d, 63d, represent radial transition areas 53e, 63e, which adjoin the radial protrusions 53d, 63d, see for example FIG. 14. The radial indentations 53c, 63c extend in the circumferential direction approximately six times as far as the radial protrusions 53d, 63d, so that in the embodiment example considered, 20 radial indentations 53c, 63c and 20 radial protrusions 53d, 63d are formed. The radial indentations 53c, 63c are set back approximately 6% of the radius relative to the radial protrusions 53d, 63d. The roller disks 53, 63 of the embodiment example under consideration have a diameter of approximately 20 cm to approximately 25 cm.

The previously described profiling of the roller disks 53, 63 of the two rollers 5, 6 according to the invention has the effect that the rollers 5, 6 are pulled over the ground in the direction of movement A by the tractor as a towing vehicle and together introduce the seed 7 previously applied to the ground into the ground to the desired depth in the vertical Z. This is achieved by the profiled edges of the first, front roller 5 penetrating into the ground with their radial protrusions 53d due to the dead weight of the roller 5 until the radial indentations 53c of the first, front roller 5 exert sufficient resistance against the ground and thereby prevent further penetration of the first, front roller 5 into the ground. Due to the previously described profiling of the edge of the first, front roller 5, a penetration depth into the ground in the vertical direction Z is achieved, which corresponds to the desired depth of the germination horizon of approximately 5 mm to 10 mm. Accordingly, the seed grains 7, which were applied comparatively evenly to the surface of the ground by the seed unit 4 in front of the first, front roller 5, are now partially pressed into the ground by the first, front roller 5.

The penetration of the first, front roller 5 into the ground simultaneously pushes soil material laterally up into the spaces between the roller disks 53 of the first, front roller 5, which can partially cover the seed 7 lying on the surface of the ground. The following second, rear roller 6 now rolls with the profiled edges of its roller disks 63 partly there, i.e. in the spaces between the roller disks 53 of the first, front roller 5, on the surface of the ground, so that any seed 7 lying there is also worked into the ground to the desired depth as described above. At the same time, seed 7 lying laterally in the transverse direction Y next to the roller disks 63 of the second, rear roller 6 can be covered with soil material or pushed into the depressions in the ground left by the roller disks 53 of the first, front roller 5.

With a sufficiently large disk thickness B and sufficiently small disk spacing D between the roller disks 53, 63 of the two rollers 5, 6, the seed 7 can thus be almost completely introduced into the desired germination horizon and at least covered with soil material, so that the seed 7 can be almost completely germinated and used. The radial indentations 53c, 63c and radial protrusions 53d, 63d of both roller disks 53, 63 are each arranged congruently per roller 5, 6 in the transverse direction Y, which can favor a grid-like introduction of the seed grains 7 into the substrate per roller 5, 6.

In order to enable the two rollers 5, 6 to follow uneven ground or to compensate for it, both rollers 5, 6 are rotatably mounted at both ends in the transverse direction Y on supporting frames 54, 64 by means of roller holders 51, 61. The supporting arms 54, 64 are each pivotably mounted on the respective side holder 16 by means of supporting frame holders 55, 65, so that the two rollers 5, 6 are suspended by means of the respective supporting arms 54, 64 in a manner such that they can pivot or swing freely relative to the rack 10 of the sowing device 1; see for example FIG. 16. The maximum swivel movements of the two rollers 5, 6 are each limited in both directions by support arm stops 56, 66, see also for example FIG. 16.

Furthermore, roller dampers 57, 67 in the form of resilient bodies are provided in each case, which are interchangeably arranged on the side holders 16 in each case in the vertical direction Z above the roller shafts 50, 60 of the two rollers 5, 6 in such a manner as to apply in each case a resilient force to the two rollers 5, 6 or their roller shafts 50, 60 in the vertical direction Z downwards and thus increase the pressure of the two rollers 5, 6 on the ground. In the embodiment example under consideration, this is done in each case by a metallic spiral spring 57, 67, which is arranged vertically aligned on both sides per roller 5, 6 between a fixed element (not designated) of the respective side holder 16 and the respective roller holder 51, 61 and acts or presses directly on the respective roller holder 51, 61, see for example FIG. 5. Due to the interchangeability of the roller dampers 57, 67, this pressure can be adapted to the respective ground by using different roller dampers 57, 67.

FIG. 18 shows a perspective view of the rear region of FIG. 5 according to a second embodiment example from the front obliquely above. FIG. 19 shows a top view of a roller damper 57, 67 of FIG. 18. FIG. 20 shows a detailed view of the lower area of FIG. 2 according to the second embodiment of FIG. 18.

In this case, the two roller dampers 57, 67 are designed as metallic spiral springs 57, 67 or as pairs of metallic spiral springs 57, 67, which can also be referred to as metallic spiral spring packs 57, 67. Two different spiral springs 57, 67 are used per pair of spiral springs 57, 67, which run in parallel and act in the same direction. A pair of spiral springs 57, 67 is arranged in each case on a common roller damper holder 58, 68, which in turn is fixedly mounted on the respective side holder 16. Each roller damper holder 58, 68 has a plurality of holes 58a, 6ba so that the positioning of the roller damper holders 58, 68 on the respective side holder 16 can be changed in discrete steps.

Each spiral spring 57, 67 extends around a respective guide 58b, 68b of the roller damper holders 58, 68, thereby stabilizing and guiding the spiral springs 57, 67. The open ends, so to speak, of the guides 58b, 68b of the roller damper holders 58, 68 are movably connected along the direction of action of the spiral springs 57, 67 to a respective tappet connection 59b, 69b, which are jointly fixedly connected to a respective tappet 59, 69. The tappets 59, 69 each rest with a curved contact surface 59a, 59b on the respective rollers 5, 6 or their roller shafts 50, 60. The spiral springs 57, 67 act on the respective tappet 59, 69 via the tappet connections 59b, 69b, so that the spring forces can be transmitted to the rollers 5, 6 or their roller shafts 50, 60, as previously described with regard to the first embodiment.

FIG. 21 shows a detailed view of the lower area of FIG. 2 according to a third embodiment. In this case, only the second, rear roller 6 has a pair of roller dampers 67 according to the second embodiment example. The first, front roller 5 is stationary or fixed.

FIG. 22 shows a detailed view of the lower area of FIG. 2 according to a fourth embodiment. In this case, only the first, front roller 5 has a pair of roller dampers 57 according to the second embodiment example. The second, rear roller 6 is stationary or fixed.

FIG. 23 shows a detailed view of the lower area of FIG. 2 according to a fifth embodiment. In this case, both rollers 5, 6 are stationary or fixed.

FIG. 24 shows a detailed view of the lower area of FIG. 2 according to a sixth embodiment. In this case, both rollers 5, 6 have a common roller damper 57 between them along the longitudinal axis X, which can be assigned to the first roller 5. For this purpose, the supporting arms 54, 64 of both rollers 5, 6 each have a tappet receiver 59c, 69c facing each other along the longitudinal axis X, which the common tappet 59a presses on from above along the vertical Z.

FIG. 25 shows a detailed view of the lower area of FIG. 2 according to a seventh embodiment. In this case, the two rollers 5, 6 or their roller shafts 50, 60 (shown using the outermost roller holders 51, 61 in each case) are rotatably mounted on a common pendulum bracket 8, wherein the pendulum bracket 8 is rotatably mounted on the frame 10 in such a manner that the two rollers 5, 6 can be tilted together about the transverse axis Y with respect to the ground. This allows a certain degree of flexibility and adaptability to the ground for both rollers 5, 6 together, while keeping the corresponding effort low. The pendulum support 8 is designed as a triangle, so that an upper pivot point 8a of the pendulum support 8 is connected to the frame 10, enabling rotary movement. The two rollers 5, 6 are equally spaced along the longitudinal axis X to the upper pivot point 8a, so that an isosceles triangle is formed

### LIST OF REFERENCE SIGNS (PART OF THE DESCRIPTION)

A direction of movement; pulling direction
B disk thickness
C disk spacing of a roller 5, 6
D disk spacing between roller disks 53, 63 of different rollers 5, 6
E shaft spacing
X longitudinal direction; depth; length
Y Y Transverse direction; width
Z vertical direction; height
X, Y X, Y Horizontal, horizontal plane
1 sowing device; sowing machine
10 rack
11 vehicle couplings
12 rubberized roller
13 seed container
14 stepping surface
15 railing
16 side holders
17 crossbar
2 track loosener
20 holders
21 holder fastenings
22 handles
23 foot elements
24 contact surface
25 foot element fastenings
3 harrowing unit
30 holder
31 holder passage openings
32 holder fastenings; holder screws
33 (spring-elastic) harrow
34 harrow holder
35 harrow fastening; harrow fastening screws
36 handle
4 seed unit
40 hopper interior
41 first wall
42 second wall
43 inlet openings
44 outlet opening; outlet slot
45 wall connections
46 holding elements of the walls 41, 42
5 first, front roller, first, front seed roller
50 roller shaft
51 roller holders
52 spacer body
53 roller disks
53a shaft receptacle
53b spacer body receptacles
53c radial indentations
53d radial protrusions
53e radial transition areas of the radial indentations 53c and the radial protrusions 53d
54 supporting arms
55 support arm holders
56 support arm stops
57 roller damper; metallic spiral spring; metallic spiral springs or metallic spiral spring pairs or metallic spiral spring packs
58 roller damper holders
58a holes of the roller damper holders 58
58b guides of the roller damper holders 58
59 tappet
59a contact surfaces of the tappets 59
59b tappet connections of tappets 5959c Tappet receptacles of supporting arms 54
6 second, rear roller; second rear seed roller
60 roller shaft
61 roller holders
62 spacer body
63 roller disks
63a shaft receptacle
63b spacer body receptacles
63c radial indentations
63d radial protrusions
63e transition areas of the radial indentations 63c and the radial protrusions 63d
64 supporting arms
65 support arm holders
66 support arm stops
67 roller damper; metallic spiral spring; metallic spiral springs or metallic spiral spring pairs or metallic spiral spring packs
68 roller damper holders
68a holes of the roller damper holders 68
68b guides of the roller damper holders 68
69 tappet
69a contact surfaces of the tappets 69
69b tappet connections of tappets 69
69c tappet receptacles of supporting arms 54
7 seeds; seed grains; grains
8 pendulum holder for the roller damper 57, 67
8a upper pivot point of the pendulum holder 8

1. A sowing device;
with a rack with at least one rotatably mounted first roller with a substantially cylindrical surface,
wherein the first roller is designed to be rolled over a ground and to incorporate seed into the ground,
characterized in that
the cylindrical surface of the first roller has alternating radial indentations and radial protrusions in the circumferential direction at least in portions, preferably in their entirety,
wherein the radial indentations each rise radially towards at least one radial protrusion, preferably towards both radial protrusions, by means of a radial transition area.

2. The sowing device according to claim 1,
wherein the radial indentations are concave.

3. The sowing device according to claim 1, wherein the radial protrusions are convex, preferably with the shape of the completely cylindrical surface of the first roller.

4. The sowing device according to claim 1,
wherein the radial indentations extend in the circumferential direction at least 3 times, preferably at least 5 times, and at most 10 times, preferably 7 times, particularly preferably approximately 6 times, as far as the radial protrusions, and/or
wherein the radial indentations each extend over at least 2% of the circumference, preferably over at least 3% of the circumference, and at most over 6% of the circumference, preferably over 5% of the circumference, particularly preferably over approximately 4% of the circumference, and/or
wherein the radial protrusions each extend over at least 0.3% of the circumference, preferably over at least 0.5% of the circumference, and at most over 1.5% of the circumference, preferably over 1.0% of the circumference, particularly preferably over approximately 0.7% of the circumference, and/or
wherein the radial indentations are set back in the radial direction by at least 3% of the radius, preferably at least 5% of the radius, and at most 10% of the radius, preferably 7% of the radius, particularly preferably approximately 6% of the radius, relative to the radial protrusions.

5. The sowing device according to claim 1,
wherein the first roller is freely suspended from the rack of the sowing device by means of at least one supporting arm, preferably at each end by means of a supporting arm,
wherein a supporting arm stop is preferably provided in at least one direction of movement of the supporting arm, preferably in both directions of movement of the supporting arm.

6. The sowing device according to claim 5,
wherein at least one, preferably replaceable, roller damper is provided between the rack of the sowing device and the first roller, preferably a roller shaft of the first roller, which is designed to counteract a deflection of the first roller in a damping manner.

7. The sowing device according to claim 1,
wherein the first roller has a plurality of, preferably stationary, roller disks, which are arranged parallel to one another and have the radial indentations and radial protrusions alternating at least in portions, preferably in their entirety, in the circumferential direction,
wherein the radial indentations and radial protrusions of a plurality of roller disks, preferably of all roller disks, are arranged corresponding to or offset with respect to one another in the circumferential direction.

8. The sowing device according to claim 7,
wherein at least one second roller with a plurality of, preferably fixed, roller disks is also rotatably mounted on the rack, preferably in the direction of movement behind the first roller,
wherein the roller disks of the first roller and the roller disks of the second roller engage with one another in the direction of movement and are preferably arranged alternately in the transverse direction.

9. The sowing device according to claim 8,
wherein the roller disks of the second roller have radial indentations, radial transition areas and radial protrusions, which are preferably formed and arranged as in the roller disks of the first roller.

10. The sowing device according to claim 8,
wherein a disk distance between a roller disk of the first roller and a roller disk of the second roller immediately adjacent in the transverse direction is less than the disk thickness, preferably approximately half the disk thickness, of the roller disk of the first roller and/or of the roller disk of the second roller.

11. The sowing device according to claim 8,
wherein the roller disks of the first roller are arranged, preferably stationary, on a roller shaft of the first roller and the roller disks of the second roller are arranged, preferably stationary, on a roller shaft of the second roller,
wherein the shaft distance between the roller shaft of the first roller and the roller shaft of the second roller is as small as possible in order to exclude contact of a roller disk with a roller.

12. The sowing device according to claim 8,
wherein the second roller is freely suspended from the rack of the sowing device by means of at least one supporting arm, preferably at each end by means of a supporting arm,
wherein a supporting arm stop is preferably provided in at least one direction of movement of the supporting arm, preferably in both directions of movement of the supporting arm.

13. The sowing device according to claim 12,
wherein between the rack of the sowing device and the second roller, preferably a roller shaft of the second roller, at least one, preferably replaceable, roller damper is provided, which is designed to counteract a deflection of the first roller in a damping manner.

14. The sowing device according to claim 1,
with at least one, preferably height-adjustable and/or exchangeable, track loosener, which is arranged in front of the first roller, and preferably in front of a harrowing unit and/or in front of a sowing unit, in the direction of movement of the sowing device, and is designed to engage in the soil and loosen it,
wherein the track loosener is preferably arranged on the sowing device where a wheel of a pulling device rolls on the ground, and/or
wherein the track loosener preferably has a plurality of foot elements with contact surfaces for substantially horizontal engagement in the ground, which are preferably height-adjustable and/or interchangeable,
wherein the contact surfaces of the foot elements are preferably curved towards the ground in the direction of movement and/or in the transverse direction, at least in portions at the edges.

15. The sowing device according to claim 1,
with at least one, preferably height-adjustable and/or exchangeable, harrowing unit, which is arranged in front of the first roller in the direction of movement of the sowing device, and is designed to smooth the soil, preferably behind a track loosener and/or in front of a seeding unit,
wherein the harrowing unit preferably has a plurality of harrows which are arranged next to one another in rows in the transverse direction and are aligned with an open end towards the ground in order to make smoothing contact therewith,
wherein the harrows are preferably resiliently designed and/or resiliently mounted on the harrowing unit, preferably in a height-adjustable and/or replaceable manner.

16. The sowing device according to claim 1,
with at least one seeding unit, which is arranged in front of the first roller in the direction of movement of the sowing device and is designed to apply seed to the soil, preferably after a track loosener and/or after a harrowing unit, and which is height-adjustable and/or interchangeable,
wherein the seed unit preferably has an outlet opening which extends in the transverse direction at least in portions, preferably completely, across the width of the first roller,
wherein the outlet opening is preferably slit-like in the transverse direction, and/or
wherein the seed unit preferably has a first wall and a second wall, which extend in the transverse direction and together form, at least in sections, an inner hopper space, from which the individual seed grains can emerge towards the ground via the outlet opening,
wherein at least one of the walls is formed at an angle to the vertical direction so as to allow seed grains to bounce off towards a, preferably slit-like, outlet opening.

17. A first roller for use in a sowing device according to claim 1,
wherein the first roller is designed to be rotatably mounted on a rack of the sowing device,
wherein the first roller has a substantially cylindrical surface,
wherein the first roller is designed to be rolled over a ground and to incorporate seed into the ground,
wherein the cylindrical surface of the first roller has alternating radial indentations and radial protrusions in the circumferential direction at least in portions, preferably in their entirety, and
wherein the radial indentations each rise radially towards at least one radial protrusion, preferably towards both radial protrusions, by means of a radial transition area.
